(19) United States
(12) Patent Application Publication
(10) Pub. No.: US 2025/0124758 A1
(43) Pub. Date: Apr. 17, 2025

(54) SKILL TREES IN GAMES IN ORDER FOR THE PLAYER TO CUSTOMIZE THEIR EXPERIENCE

(71) Applicant: IGT, Las Vegas, NV (US)

(72) Inventor: Julian Hofer, Pischelsdorf am Kulm (AT)

(21) Appl. No.: 18/378,987

(22) Filed: Oct. 11, 2023

(51) Int. Cl. G07F 17/32; G07F 17/34

(52) U.S. Cl. CPC G07F 17/3227; G07F 17/323; G07F 17/34

(57) ABSTRACT

Embodiments of the present disclosure are directed to allowing players to adjust elements of an electronic game of chance on demand. Generally speaking, upon initiation of an electronic game of chance, a default configuration for the game can be used. The player can then be given an option to modify this configuration. Upon selection of this option, a menu of choices can be provided with the choices being available through a presented progression mechanism such as a skill tree. Once the player has selected desired options, the game configuration can be updated. In some cases, the updated configuration can be saved and later applied to subsequent games.

### BACKGROUND

The present disclosure is generally directed to operating an electronic game on a gaming system and, more particularly, to configuring an electronic game of chance on demand according to a progression mechanism.

In a casino environment, games which provide a story, a sense of progression, and/or an impression of an ability to control or influence a configuration of the game can increase player engagement. Increased player engagement in turns leads to increased use of the game and revenues for the operator of the casino. Thus, rather than providing a static game with wins or losses, there is a need to provide an ability to control or influence a configuration of a game.

### BRIEF SUMMARY

Embodiments of the present disclosure are directed to configuring an electronic game of chance on demand according to a progression mechanism. According to one embodiment, a method for operating an electronic game of chance can comprise initiating the electronic game of chance on a gaming system. For example, the electronic game of chance can be initiated using a default configuration. An option to change the default configuration of the electronic game of chance can be presented to a player of the electronic game of chance and an indication the player of the electronic game of chance has selected the option to change the default configuration of the electronic game of chance can be received. In response to the received indication the player of the electronic game of chance has selected the option to change the default configuration of the electronic game of chance, a menu of a plurality of options for changing the default configuration of the electronic game of chance can be presented. Each option of the plurality of options can relate to operation of a feature of the electronic game of chance and the plurality of options can be presented in a progression mechanism representation. For example, the progression mechanism representation can comprise a skill tree.

An indication of a selected plurality of options from the menu of the plurality of options for changing the default configuration of the electronic game of chance can be received. The selected plurality of options can be selected according to the presented progression mechanism representation. The default configuration of the electronic game of chance can then be updated based on the received indication of the elected plurality of options. For example, the selected plurality of options can comprise any one or more of an option to increase an appearance rate of a selected symbol in the electronic game of chance, an option to increase a chance to trigger a mystery bonus in the electronic game of chance, an option to increase a number of free spins won on a feature trigger in the electronic game of chance, an option to increase a wild multiplier during a free spin feature in the electronic game of chance, and/or others. In some cases, the updated configuration of the electronic game of chance can be saved to an account mechanism for the player.

According to another embodiment, a gaming system can comprise a display device, a processor coupled with the display device, and a memory coupled with and readable by the processor. The memory can store therein a set of instructions which, when executed by the processor, causes the processor to initiate an electronic game of chance on the gaming system using a default configuration. For example, the electronic game of chance can comprise a slots game.

The instructions can further cause the processor to present, through the display device, to a player of the electronic game of chance, the option to change the default configuration of the electronic game of chance, receive an indication the player of the electronic game of chance has selected an option to change the default configuration of the electronic game of chance, and in response to the received an indication the player of the electronic game of chance has selected the option to change the default configuration of the electronic game of chance, present, through the display device, a menu of a plurality of options for changing the default configuration of the electronic game of chance, each option of the plurality of options related to operation of a feature of the electronic game of chance and wherein the plurality of options are presented in a progression mechanism representation. For example, the progression mechanism can comprise a plurality of levels, each level of the plurality of levels comprising a plurality of configuration options for the electronic game of chance. In such cases, the plurality of levels can comprise a first level and a second level and the plurality of configuration options available in the second level can depend upon a selection of a configuration option in the first level.

The instructions can further cause the processor to receive an indication of a selected plurality of options from the menu of the plurality of options for changing the default configuration of the electronic game of chance, wherein the selected plurality of options are selected according to the presented progression mechanism representation. In some cases, a number of options in the selected plurality of options is limited to a predefined maximum number of options. The instructions can further cause the processor to update the default configuration of the electronic game of chance based on the received indication of the selected plurality of options. In some cases, the instructions can further cause the processor to save the selected plurality of options and apply the saved selected plurality of options to a subsequent electronic game of chance initiated for the player.

According to yet another embodiment, a non-transitory, computer-readable medium can comprise a set of instructions stored therein which, when executed by a processor, causes the processor to initiate the electronic game of chance on the gaming system, wherein the electronic game of chance is initiated using a default configuration, present to a player of the electronic game of chance, an option to change the default configuration of the electronic game of chance, receive an indication the player of the electronic game of chance has selected the option to change the default configuration of the electronic game of chance, in response to the received indication the player of the electronic game of chance has selected the option to change the default configuration of the electronic game of chance, present a menu of a plurality of options for changing the default configuration of the electronic game of chance, each option of the plurality of options related to operation of a feature of the electronic game of chance and wherein the plurality of options are presented in a progression mechanism representation, receive an indication of a selected plurality of options from the menu of the plurality of options for changing the default configuration of the electronic game of chance, wherein the selected plurality of options are selected according to the presented progression mechanism representation, and update the default configuration of the electronic game of chance based on the received indication of the elected plurality of options. For example, the progression mechanism representation can comprise a skill tree. The selected plurality of options can comprise any one or more of an option to increase an appearance rate of a selected symbol in the electronic game of chance, an option to increase a chance to trigger a mystery bonus in the electronic game of chance, an option to increase a number of free spins won on a feature trigger in the electronic game of chance, an option to increase a wild multiplier during a free spin feature in the electronic game of chance, and/or others.

Additional features and advantages are described herein and will be apparent from the following Description and the figures.

BRIEF DESCRIPTION OF THE SEVERAL VIEWS OF THE DRAWINGS

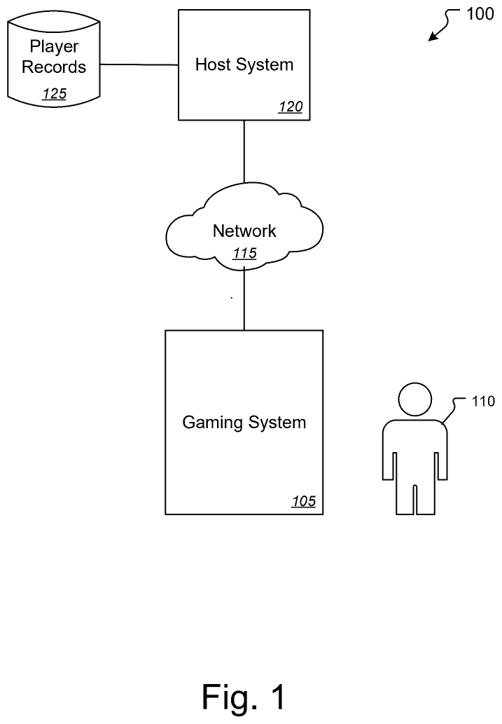

FIG. 1 is a block diagram illustrating an exemplary environment in which embodiments of the present disclosure may be implemented.

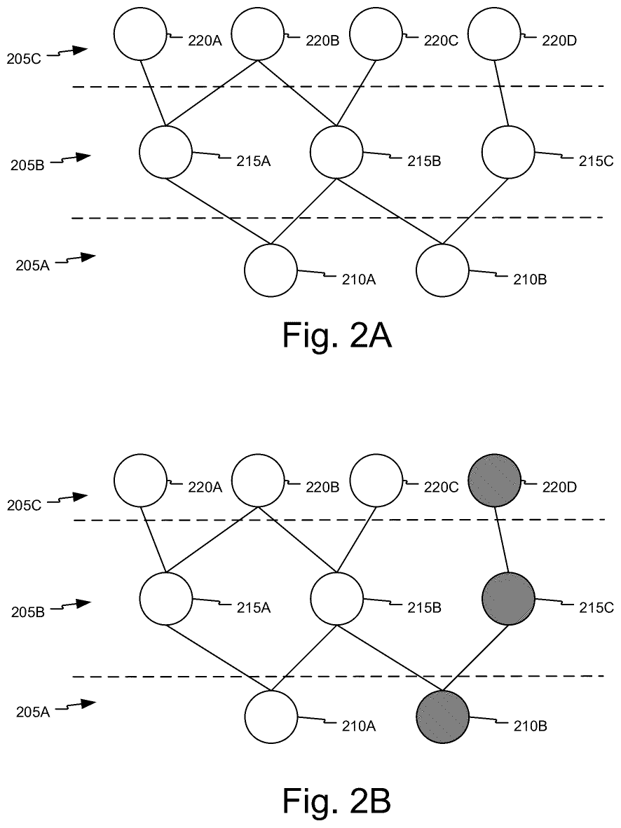

FIGS. 2A and 2B are diagrams illustrating an exemplary progression mechanism as may be used in various embodiments of the present disclosure.

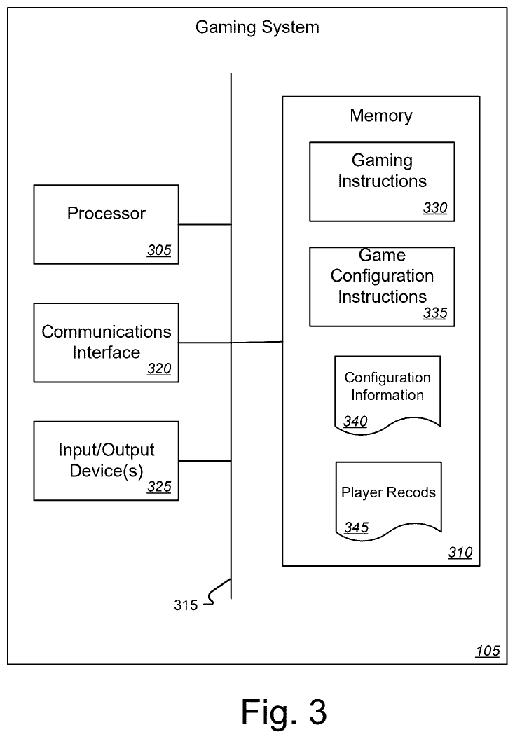

FIG. 3 is a block diagram illustrating additional details of components of an exemplary gaming system according to one embodiment of the present disclosure.

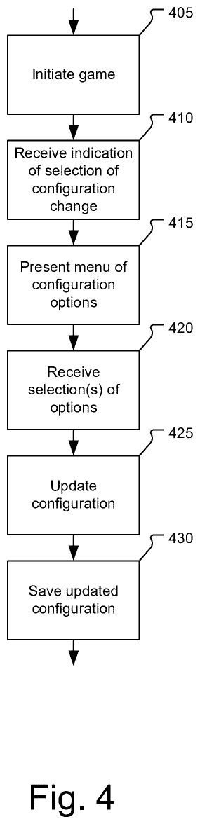

FIG. 4 is a flowchart illustrating an exemplary process for operating an electronic game of chance according to one embodiment of the present disclosure.

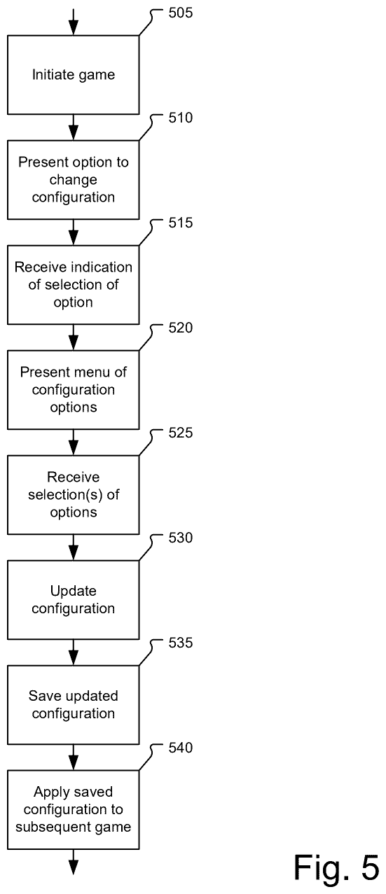

FIG. 5 is a flowchart illustrating another exemplary process for operating an electronic game of chance according to one embodiment of the present disclosure.

### DETAILED DESCRIPTION

Embodiments of the present disclosure are directed to allowing players to adjust elements of an electronic game of chance on demand. Generally speaking, upon initiation of an electronic game of chance, a default configuration for the game can be used. The player can then be given an option to modify this configuration. Upon selection of this option, a menu of choices can be provided with the choices being available through a presented progression mechanism such as a skill tree. As used herein, the term skill tree refers to a visual, hierarchical representation of options that can branch from one selected option to one or more other, subsequent options. Once the player has selected desired options, the game configuration can be updated. In some cases, the updated configuration can be saved and later applied to subsequent games.

FIG. 1 is a block diagram illustrating an exemplary environment in which embodiments of the present disclosure may be implemented. As illustrated in this example, the environment 100 can include a gaming system 105. The gaming system 105 can execute any of a wide variety of electronic games of chance including, but not limited to, slots, video slots, video poker, keno, blackjack, etc. to be played by a player 110, e.g., in a casino or other gaming venue. Typically, the game will be configured and conducted according to a set of predefined configuration parameters. Embodiments of the present disclosure are directed to allowing the player 110 to modify at least some of these predefined configuration parameters to affect the operation, appearance, and/or other features and/or functions of the electronic game of chance.

More specifically, the gaming system 105 can initiate the electronic game of chance using a default or other predefined configuration, present to a player 110 of the electronic game of chance, an option to change the default configuration of the electronic game of chance, receive an indication the player of the electronic game of chance has selected the option to change the default configuration of the electronic game of chance, and in response to the received indication the player of the electronic game of chance has selected the option to change the default configuration of the electronic game of chance, present a menu of a plurality of options for changing the default configuration of the electronic game of chance. Each option of the plurality of options can be related to operation of a feature of the electronic game of chance and the plurality of options can be presented in a progression mechanism representation, e.g., a skill tree.

The gaming system 105 can receive an indication of a selected plurality of options from the menu of the plurality of options for changing the default configuration of the electronic game of chance, wherein the selected plurality of options are selected according to the presented progression mechanism representation, and update the default configuration of the electronic game of chance based on the received indication of the elected plurality of options. For example, the progression mechanism representation can comprise a skill tree. The selected plurality of options can comprise any one or more of an option to increase an appearance rate of a selected symbol in the electronic game of chance, an option to increase a chance to trigger a mystery bonus in the electronic game of chance, an option to increase a number of free spins won on a feature trigger in the electronic game of chance, an option to increase a wild multiplier during a free spin feature in the electronic game of chance, and/or others.

In some cases, the gaming system 105 can save the updated configuration of the electronic game of chance, e.g., associated with a player card or other identifier for the player 110. Once saved, the updated configuration can then be applied to subsequent games played by the same player 110. According to one embodiment, the gaming system 105 can be coupled with a communications network 115. The communications network 115 can comprise any one or more wired and/or wireless local-area and/or wide-area networks as known in the art including, but not limited to, the Internet. Also coupled with the communications network 115 can be one or more host systems 120. The host systems can comprise any one or more servers and/or other computing devices. In some cases, the gaming system 105 may provide the updated configuration for the game to the host system 120 via the communications network 115 to be saved by the host system 120 in a set of player records 125. This saved configuration information can then later be provided by the host system 120 to the same gaming system 105 or even a different gaming system (not shown here) to configure a subsequent electronic game of chance initiated by the same player 110.

FIGS. 2A and 2B are diagrams illustrating an exemplary progression mechanism as may be used in various embodiments of the present disclosure. As illustrated in this example, the progression mechanism, such as a skill tree, can comprise a number of hierarchical levels 205A-205C. Each level of the plurality of levels can comprise a plurality of configuration options 210A-210B, 215A-215C, and 220A-220D for the electronic game of chance. For example, the plurality of levels can comprise a first level 205A and a second level 205B and the plurality of configuration options 215A-215C available in the second level 205B can depend upon a selection of a configuration option 210A-201B in the first level 205A. For example, and as illustrated in FIG. 2B, upon selection of option 210A, options 215A and 215B in the second level 205B and options 220A-220C in the third level 205C remain available for selection while options 210B, 215C and 220D are no longer available for selection.

FIG. 3 is a block diagram illustrating additional details of components of an exemplary gaming system according to one embodiment of the present disclosure. As illustrated in this example, a gaming system 105 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the gaming system 105 as described herein.

The memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 and one or more input/output devices 325 via the communications bus 315. The communication interfaces 320 can comprise, for example, a Bluetooth, WiFi, cellular, and/or other type of wireless communications interface. The input/output devices 325 can include, but are not limited to a display device such as a Liquid Crystal Display (LCD), Light Emitting Diode (LED), Organic Light Emitting Diode (OLED), or other type of display.

The memory 310 can store therein a set of gaming instructions 330 which, when executed by the processor 305, cause the processor 305 to execute an electronic game and present a representation of the game one a display device or other input/output device 325. The memory 310 can also store therein a set of game configuration instructions 335 which, when executed by the processor 305, causes the processor 305 to initiate an electronic game of chance on the gaming system 105 using a default configuration. For example, the electronic game of chance can comprise a slots game and the default configuration can be stored in a set of configuration information 340 maintained in the memory 310 of the gaming system 105.

The game configuration instructions 335 can further cause the processor 305 to present, through the display device and/or other input/output device(s) 325, to a player of the electronic game of chance, the option to change the default configuration of the electronic game of chance, receive an indication the player of the electronic game of chance has selected an option to change the default configuration of the electronic game of chance, and in response to the received an indication the player of the electronic game of chance has selected the option to change the default configuration of the electronic game of chance, present, through the display device and/or other input/output device 325, a menu of a plurality of options for changing the default configuration of the electronic game of chance, each option of the plurality of options related to operation of a feature of the electronic game of chance and wherein the plurality of options are presented in a progression mechanism representation. For example, the progression mechanism can comprise a plurality of levels, each level of the plurality of levels comprising a plurality of configuration options for the electronic game of chance. In such cases, the plurality of levels can comprise a first level and a second level and the plurality of configuration options available in the second level can depend upon a selection of a configuration option in the first level.

The game configuration instructions 335 can further cause the processor 305 to receive an indication of a selected plurality of options from the menu of the plurality of options for changing the default configuration of the electronic game of chance, wherein the selected plurality of options are selected according to the presented progression mechanism representation. In some cases, a number of options in the selected plurality of options is limited to a predefined maximum number of options. The game configuration instructions 335 can further cause the processor 305 to update the default configuration of the electronic game of chance based on the received indication of the selected plurality of options. In some cases, the game configuration instructions 335 can further cause the processor to save the selected plurality of options, e.g., in a player record 345 maintained in the memory 310 of the gaming system 105 or elsewhere, and apply the saved selected plurality of options to a subsequent electronic game of chance initiated for the player.

FIG. 4 is a flowchart illustrating an exemplary process for operating an electronic game of chance according to one embodiment of the present disclosure. As illustrated in this example, the process can begin with initiating 405 the electronic game of chance on a gaming system 105. For example, the electronic game of chance can be initiated 405 using a default or other previously defined configuration. An indication the player of the electronic game of chance has requested to change the default configuration of the electronic game of chance can be received 410, e.g., by the player selecting a presented option or otherwise indicating the desire to change the game configuration. In response to the received indication, a menu of a plurality of options for changing the default configuration of the electronic game of chance can be presented 415. Each option of the plurality of options can relate to operation of a feature of the electronic game of chance and the plurality of options can be presented in a progression mechanism representation as described above. For example, the progression mechanism representation can comprise a skill tree.

An indication of a selected plurality of options from the menu of the plurality of options for changing the default configuration of the electronic game of chance can be received 420. The selected plurality of options can be selected according to the presented progression mechanism representation. The default configuration of the electronic game of chance can then be updated 425 based on the received indication of the elected plurality of options. For example, the selected plurality of options can comprise any one or more of an option to increase an appearance rate of a selected symbol in the electronic game of chance, an option to increase a chance to trigger a mystery bonus in the electronic game of chance, an option to increase a number of free spins won on a feature trigger in the electronic game of chance, an option to increase a wild multiplier during a free spin feature in the electronic game of chance, and/or others. In some cases, the updated 425 configuration of the electronic game of chance can be saved 430 to an account mechanism for the player.

FIG. 5 is a flowchart illustrating another exemplary process for operating an electronic game of chance according to one embodiment of the present disclosure. As illustrated in this example, the process can begin with initiating an electronic game of chance on the gaming system using a default configuration. For example, the electronic game of chance can comprise a slots game.

Am option to change the default configuration of the electronic game of chance can be presented 510 and an indication the player of the electronic game of chance has selected an option to change the default configuration of the electronic game of chance can be received 515. In response to the received 515 indication the player of the electronic game of chance has selected the option to change the default configuration of the electronic game of chance, a menu of a plurality of options for changing the default configuration of the electronic game of chance can be presented 520. Each option of the plurality of options can be related to operation of a feature of the electronic game of chance and the plurality of options can be presented 520 in a progression mechanism representation. For example, the progression mechanism can comprise a plurality of levels, each level of the plurality of levels comprising a plurality of configuration options for the electronic game of chance. In such cases, the plurality of levels can comprise a first level and a second level and the plurality of configuration options available in the second level can depend upon a selection of a configuration option in the first level.

An indication of a selected one or more options from the menu of the plurality of options for changing the default configuration of the electronic game of chance can be received. 525. The selected plurality of options can be selected according to the presented 520 progression mechanism representation. In some cases, a number of options in the selected plurality of options can be limited to a predefined maximum number of options. The default configuration of the electronic game of chance can then be updated 530 based on the received indication of the selected plurality of options. In some cases, the selected plurality of options can be saved 535 and applied 540 to a subsequent electronic game of chance initiated for the player.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game of chance, the method comprising:
initiating, by a processor of a gaming system, the electronic game of chance on the gaming system, wherein the electronic game of chance is initiated using a default configuration;
presenting, by the processor of the gaming system, to a player of the electronic game of chance, an option to change the default configuration of the electronic game of chance;
receiving, by the processor of the gaming system, an indication the player of the electronic game of chance has selected the option to change the default configuration of the electronic game of chance;
in response to the received indication the player of the electronic game of chance has selected the option to change the default configuration of the electronic game of chance, presenting, by the processor of the gaming system, a menu of a plurality of options for changing the default configuration of the electronic game of chance, each option of the plurality of options related to operation of a feature of the electronic game of chance and wherein the plurality of options are presented in a progression mechanism representation;
receiving, by the processor of the gaming system, an indication of a selected plurality of options from the menu of the plurality of options for changing the default configuration of the electronic game of chance, wherein the selected plurality of options are selected according to the presented progression mechanism representation; and
updating, by the processor of the gaming system, the default configuration of the electronic game of chance based on the received indication of the elected plurality of options.

2. The method of claim 1, wherein the progression mechanism representation comprises a skill tree.

3. The method of claim 1, wherein the selected plurality of options comprises an option to increase an appearance rate of a selected symbol in the electronic game of chance.

4. The method of claim 1, wherein the selected plurality of options comprises an option to increase a chance to trigger a mystery bonus in the electronic game of chance.

5. The method of claim 1, wherein the selected plurality of options comprises an option to increase a number of free spins won on a feature trigger in the electronic game of chance.

6. The method of claim 1, wherein the selected plurality of options comprises an option to increase a wild multiplier during a free spin feature in the electronic game of chance.

7. The method of claim 1, further comprising saving, by the processor of the gaming system, the updated configuration of the electronic game of chance to an account mechanism for the player.

8. A gaming system comprising:
a display device;
a processor coupled with the display device;
a memory coupled with and readable by the processor and storing therein a set of instructions which, when executed by the processor, causes the processor to:
initiate an electronic game of chance on the gaming system using a default configuration;
receive an indication the player of the electronic game of chance has selected an option to change the default configuration of the electronic game of chance;
in response to the received an indication the player of the electronic game of chance has selected the option to change the default configuration of the electronic game of chance, present, through the display device, a menu of a plurality of options for changing the default configuration of the electronic game of chance, each option of the plurality of options related to operation of a feature of the electronic game of chance and wherein the plurality of options are presented in a progression mechanism representation;
receive an indication of a selected plurality of options from the menu of the plurality of options for changing the default configuration of the electronic game of chance, wherein the selected plurality of options are selected according to the presented progression mechanism representation; and
update the default configuration of the electronic game of chance based on the received indication of the selected plurality of options.

9. The gaming system of claim 8, wherein the instructions further cause the processor to present, through the display device, to a player of the electronic game of chance, the option to change the default configuration of the electronic game of chance.

10. The gaming system of claim 8, wherein the progression mechanism comprises a plurality of levels, each level of the plurality of levels comprising a plurality of configuration options for the electronic game of chance.

11. The gaming system of claim 10, wherein the plurality of levels comprises a first level and a second level and wherein the plurality of configuration options available in the second level depend upon a selection of a configuration option in the first level.

12. The gaming system of claim 8, wherein a number of options in the selected plurality of options is limited to a predefined maximum number of options.

13. The gaming system of claim 8, wherein the instructions further cause the processor to:
save the selected plurality of options; and
apply the saved selected plurality of options to a subsequent electronic game of chance initiated for the player.

14. The gaming system of claim 8, wherein the electronic game of chance comprises a slots game.

15. A non-transitory, computer-readable medium comprising a set of instructions stored therein which, when executed by a processor, causes the processor to:
initiate the electronic game of chance on the gaming system, wherein the electronic game of chance is initiated using a default configuration;
present to a player of the electronic game of chance, an option to change the default configuration of the electronic game of chance;
receive an indication the player of the electronic game of chance has selected the option to change the default configuration of the electronic game of chance;
in response to the received indication the player of the electronic game of chance has selected the option to change the default configuration of the electronic game of chance, present a menu of a plurality of options for changing the default configuration of the electronic game of chance, each option of the plurality of options related to operation of a feature of the electronic game of chance and wherein the plurality of options are presented in a progression mechanism representation;
receive an indication of a selected plurality of options from the menu of the plurality of options for changing the default configuration of the electronic game of chance, wherein the selected plurality of options are selected according to the presented progression mechanism representation; and
update the default configuration of the electronic game of chance based on the received indication of the elected plurality of options.

16. The non-transitory, computer-readable medium of claim 15, wherein the progression mechanism representation comprises a skill tree.

17. The non-transitory, computer-readable medium of claim 15, wherein the selected plurality of options comprises an option to increase an appearance rate of a selected symbol in the electronic game of chance.

18. The non-transitory, computer-readable medium of claim 15, wherein the selected plurality of options comprises an option to increase a chance to trigger a mystery bonus in the electronic game of chance.

19. The non-transitory, computer-readable medium of claim 15, wherein the selected plurality of options comprises an option to increase a number of free spins won on a feature trigger in the electronic game of chance.

20. The non-transitory, computer-readable medium of claim 15, wherein the selected plurality of options comprises an option to increase a wild multiplier during a free spin feature in the electronic game of chance.
